(19) United States
(12) Patent Application Publication
(10) Pub. No.: US 2006/0212472 A1
(43) Pub. Date: Sep. 21, 2006

(54) Method and system for creating a rich media content portal using third-party commercial portal application software

(75) Inventors: Aerock Fox, Vancouver (CA); Carol Ann Jenner, Vancouver (CA)

Correspondence Address: OYEN, WIGGS, GREEN & MUTALA LLP;480 - THE STATION, 601 WEST CORDOVA STREET, VANCOUVER, BC, V6B 1G1, CA

(73) Assignee: Wavenetworx Inc., Vancouver (CA)

(21) Appl. No.: 11/289,276

(22) Filed: Nov. 30, 2005

Related U.S. Application Data
(60) Provisional application No. 60/631,432, filed on Nov. 30, 2004.

(51) Int. Cl. G06F 7/00

(52) U.S. Cl. 707/102

(57) ABSTRACT

A method of creating an online web application for managing Rich media content and documents of a user is described which involves providing a secure website accessible to the user over a computer network; providing commercial portal application software to store and index files and provide security; providing the user with one or more roles to determine security rights; defining the metadata fields for the Rich media content and documents; the user defining security roles of secondary users; a user uploading Rich media content to a database; generating an XML document containing information identifying the Rich media content; and the commercial portal application indexing the XML document for searching by a user.

### CROSS-REFERENCE TO RELATED APPLICATIONS

This application claims priority from U.S. provisional application No. 60/631,432 filed Nov. 30, 2004, which is incorporated herein by reference.

### TECHNICAL FIELD

The invention relates to the process of creating a Rich Media Content Portal using commercial portal software that provides application programming interfaces (“API's”) and other web service technologies, i.e. Microsoft's SharePoint Technologies.

### BACKGROUND ART

Traditionally, business portals are overlooked by Entertainment Professionals because of the impracticality of the out-of-the-box workflow of most commercial business portals. The commercial portal's primary focus is document management for a traditional Fortune 500 type business. Document (word processing or text files) management is only part of the total requirement of the Entertainment Professional in respect of portal technology. The other part is a way to deal with Rich Media content or Digital assets, such as images, video clips and audio clips. “Rich media content’ is defined herein as digital video, audios and image files.

Currently, Entertainment Professionals have no off-the-shelf technology available to them to help them manage their digital assets, and currently no portal is available on the market that will allow Entertainment Professionals to manage both their documents (word processing or text files) and their digital assets. This problem does not just apply to the Entertainment Professional, but also to Insurance Corporations, the Travel Industry and Sports Training. In the past, companies, such as these, have spent time and a considerable amount of money trying to rework existing workflows of various commercial portals with the desire to have a product that works with the user and meets the needs of all their users. The result of such work is often met with failure due to a poor choice of consultants; technology; internal political issues at the Entertainment Company; financial concerns; or security concerns. Furthermore, companies who manage to make it through the software process often find they have a portal with a low adoption rate; frustrated users wanting more; and a portal will remain largely unused by the majority of their users.

Currently in the entertainment marketplace as an example, custom portal solutions exist and are being used, however these solutions do not handle digital assets (rich media content). They focus on working with other technologies: payroll and accounting software; scheduling and budgeting software. Often a large number of users whose primary concerns are not documents, but digital, i.e. Videos, have not had their needs meet and are still searching for a solution. Furthermore, larger companies (e.g. Studios), are wary of online companies that host their data, using technology they already have licenses for. The present invention will be able to work with them and allow these companies, to license the invention, while still using the corporate licensing already established by their companies with Microsoft, and other third party vendors.

### DISCLOSURE OF INVENTION

The present invention provides a method of creating an online web application that works in the workflow of the customer, using a third-party commercial portal, such as Microsoft SharePoint Portal Server and SharePoint Services, to store, index and provide security.

It is therefore an object of the invention to provide the ability to manage, store, distribute and collaborate on documents and rich media content, using a workflow that will promote adoption. The invention will work for a large corporation (Studio) and a small independent company which cannot afford the cost of development to make commercial portal software meet its needs. The invention will also permit a company with existing portal technology to maximize their adoption rate, by using custom net software that will work the way the user would work in their business. An advantage of the invention is that it will also work with integrated Calendaring and Contact Management and the applicant's ePitch™ and ePackage™ applications.

### BRIEF DESCRIPTION OF DRAWINGS

In drawings which disclose a preferred embodiment of the inventions:

FIG. 1 is a Flowchart illustrating the architecture of the system.

FIG. 2 shows the hierarchical relationship between projects, departments, sub-departments and departmental artifacts.

### BEST MODE(S) FOR CARRYING OUT THE INVENTION

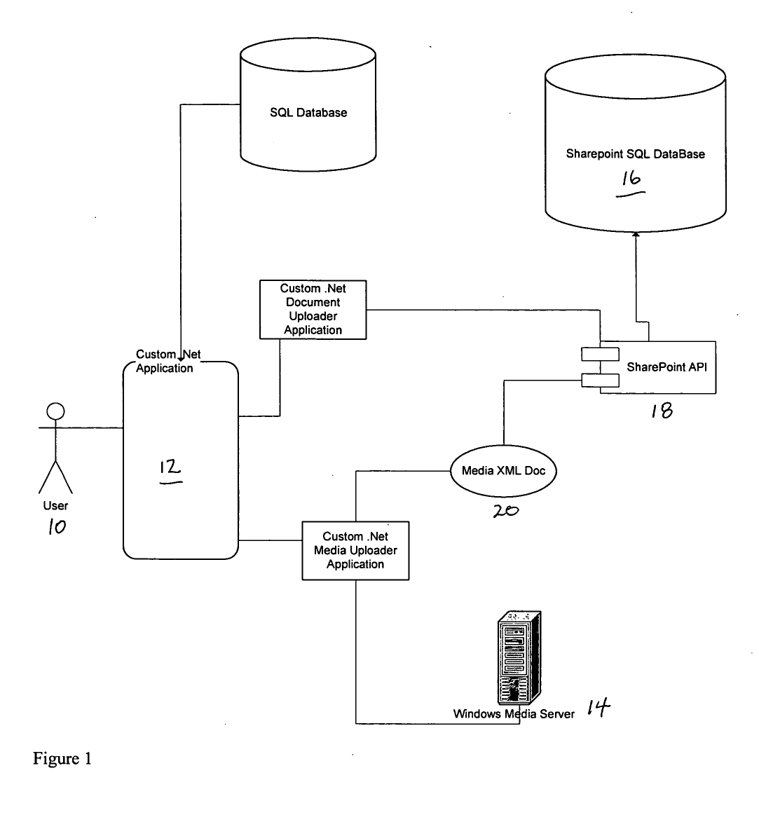

With reference to FIG. 1, a user 10 will log into a secure website 12, which is written in some form of web scripting technology (i.e. Microsoft .Net, JSP). The website will use the same security as the portal server. For example, Microsoft SharePoint relies on Microsoft's Active Directory to provide Single-Sign On. Single-Sign-On is an industry term that will allow a user to sign on once to a domain, and never have to authenticate again during the life of the session, even across servers. Active Directory is generally used to provide such technology.

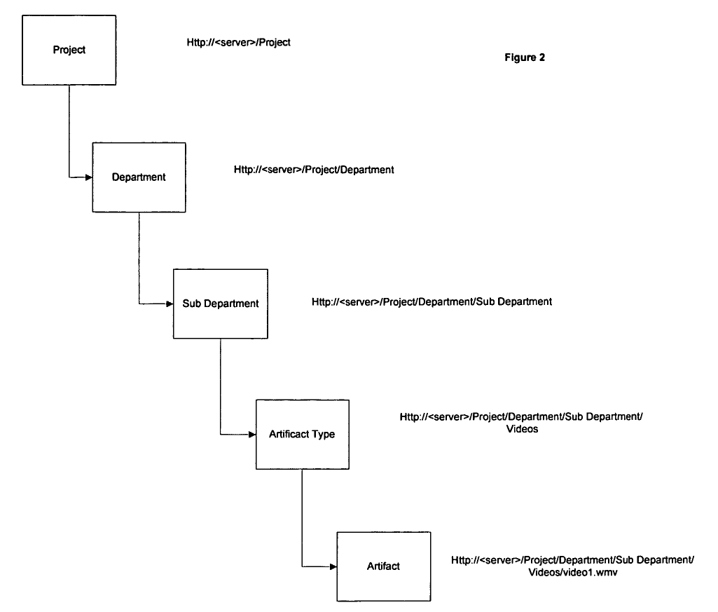

Each User will have one or more “roles”. The Role of the User will determine their security rights and levels. If the User is, for example a Production Owner, then they may be allowed to set up a project or production, or in the case of Insurance—a claim. The production would be at the highest level of navigation, the department of the production would be the sub level, and then the artifacts (documents, videos) of the department, as a sub-sub level and so on. For example in FIG. 2, a Movie or Project would have departments, and in those departments there would be various artifacts—documents, videos, etc.

A Production Owner may have rights, for example, to create a project. During this Project Setup, the Production Owner will create departments, define the departmental artifacts and define the metadata fields for each artifact. The invention would store this information in a database 16, and then using the API 18 provided with the commercial portal software, set up the portal to reflect the navigational requirements of a project. There is no set limit on the type and number of metadata fields for an artifact type. It is open and flexible for the users and their needs.

For example, Microsoft SharePoint uses Topics as their navigational points. If a user were to set up these topics using the out of the box SharePoint Software, it would look similar to this: Http://<server>/Big Movie/Casting/Auditions/NY. The .Net workflow navigation would also be similar but in a layout that would be more agreeable to the users.

After a project is set up, the Production Owner assigns Users and their security Roles, such as Uploader, Viewer, etc. The roles define both the .Net UI Application and the Portal (SharePoint) rights of the user. If a User is an Uploader, they would then be able to upload a departmental artifact. The upload modules would define how to handle this artifact. If it was a document, the document would be put into the portal and managed by the Portal's core software.

If the User is an Uploader, they click and upload a departmental artifact, and that artifact is for example a Video. The Uploader would upload the video and place it on the hard drive. The location of this would be determined by server security rights but also if Windows Media Server 14 is used, where the videos would be found for display. The invention would then generate an XML document 20 that would have pertinent information of the video, such as Date, Size, video type and file location, but also the values of the metadata fields defined during Project Setup. The XML would then act as a document and fall under the same security provisions as a regular document that was placed in the portal, and the portal would be instructed to index this document for searching, therefore making all the information a user enters searchable, and in the case of SharePoint, even the data inside a PDF file can be found. Using XML permits flexibility with the metadata on each Rich Media Content, and storage of as much information as required to make the front end application run seamlessly.

Another part of the invention is that if a larger corporation already has Active Directory technology in place, and has already purchased SharePoint Technologies, then the corporation may then license the invention or purchase the source code. The upload modules would also be intuitive enough to not only upload a document but find one that was uploaded to an FTP server. If a third party software was used in the uploading the video, and it placed a xml file that is of the right format or of a recognizable format, then the upload module could be automated to put the newly FTP'd file into the portal with little or no action on the user's part.

Further, the invention may use the same content to work with the applicant's ePitch™, ePackage™ applications as well as the integrated Calendaring and Content Management Systems. The Uploader can also be a Viewer of documents not uploaded by them. The Uploader can assign permissions to other users, such as the ability to download, modify and delete. That User then becomes a Viewer.

What is claimed is:

1. A method of creating an online web application for managing Rich media content and documents of a user comprising:
i) providing a secure website accessible to said user over a computer network;
ii) providing commercial portal application software to store and index files and provide security;
iii) providing said user with one or more roles to determine security rights;
iv) defining the metadata fields for said Rich media content and documents;
v) said user defining security roles of secondary users;
vi) a user uploading Rich media content to a database;
vii) generating an XML document containing information identifying said Rich media content;
viii) said commercial portal application indexing said XML document for searching by a user.

2. A system for online management of Rich media content and documents of a user comprising:
i) a server for providing a secure website accessible to said user over a computer network;
ii) commercial portal application software on said server for storing and indexing files and providing security;
iii) means for providing said user with one or more roles to determine security rights;
iv) means for defining the metadata fields for said Rich media content and documents;
v) means for said user to define security roles of secondary users;
vi) a database and means for a user to upload Rich media content to said database;
vii) means for generating an XML document containing information identifying said Rich media content;
whereby said commercial portal application indexes said XML document for searching by a user.
